(19) United States
(12) Patent Application Publication
(10) Pub. No.: US 2022/0226762 A1
(43) Pub. Date: Jul. 21, 2022

(54) AIR PURIFIER AND FILTER ASSEMBLY THEREOF

(71) Applicant: Yung-Jen Chen, Kaohsiung (TW)

(72) Inventor: Yung-Jen Chen, Kaohsiung (TW)

(21) Appl. No.: 17/648,547

(22) Filed: Jan. 21, 2022

(30) Foreign Application Priority Data
Jan. 21, 2021 (TW) 110102382

(51) Int. Cl. B01D 46/00; B01D 46/58; B01D 46/52; A62B 7/10

(52) U.S. Cl. CPC B01D 46/0041; B01D 46/58; B01D 2279/40; B01D 46/0005; A62B 7/10; B01D 46/521

(57) ABSTRACT

An air purifier is disclosed and includes a housing, a cover, a filter assembly, and a fan. The housing includes a casing and a shell which are detachable from each other, the casing has a venting portion. The cover has at least one breathable part. The filter assembly is configured in a space defined by the casing and the cover. The filter assembly includes a transformable body and at least one filter. The transformable body has two passage portions. The filter is located between the two passage portions. The transformable body is configured to be transformable to change airflow through the filter. The venting portion, the two passage portions, the breathable part are coupled in fluid communication. The fan is disposed in the housing and configured to generate airflow. The filter assembly is suitable for different situations of ventilating for fixed-locations and being worn for protection from smoke.

### CROSS REFERENCE TO RELATED APPLICATIONS

This application claims the priority of Taiwan Patent Application No. 110102382, filed on Jan. 21, 2021, the disclosure of which is incorporated herein by reference.

### FIELD OF INVENTION

The present disclosure relates to the technical field of filtering, which particularly relates to an air purifier and a filter assembly thereof that integrate the function of a fire escape filter mask.

### BACKGROUND OF INVENTION

According to statistics, nearly 80% of the fatal causes of fires are caused by dense smoke rather than direct contact with flames. Most of the reasons for death in fire are first inhaling toxic gas, and then being suffocated and losing unconsciousness.

For example, when a flame burns furniture and other objects, toxic gases are generated, resulting toxic gases in high concentrations in the dense smoke of the fire, especially carbon monoxide. After the toxic gas enters the human body, it quickly combines with red blood cells, making the blood unable to deliver oxygen, causing the human body to die due to lack of oxygen.

However, ordinary households rarely have smoke protection masks needed to escape from fire. The reason is that the existing smoke protection masks require a strong smoke filtering function and have an independently designed filter. Although ordinary households may have air purifiers, due to different functional orientations, filters with smoke protection functions cannot be directly used in the existing air purifiers. In the past, there were some single-function products, but they still need to be improved.

As a result, it is necessary to provide a technical solution different from the past to solve the problems existing in the conventional technology.

### SUMMARY OF INVENTION

An object of the present disclosure is to provide an air purifier, so that a filter is suitable for different situations of ventilating for fixed-locations and being worn for protection from smoke.

Another object of the present disclosure is to provide a filter assembly, so that a filter is suitable for different situations of ventilating for fixed-locations and being worn for protection from smoke.

To achieve the above object, the present disclosure provides an air purifier. The air purifier comprises a housing comprising a casing and a shell being detachable from each other, wherein the casing comprises a venting portion, a cover comprising at least one breathable part, a filter assembly configured in a space defined by the casing and the cover, wherein the filter assembly comprises a transformable body and at least one filter, the transformable body comprises two passage portions, the filter is located between the two passage portions, the transformable body is configured to be transformable to change airflow through the filter, and the venting portion, the two passage portions, and the breathable part are coupled in fluid communication, and a fan disposed in the housing and configured to generate airflow.

In one embodiment of the present disclosure, the casing, the cover, and the filter assembly are configured to form a filter mask.

In one embodiment of the present disclosure, the transformable body comprises a frame and at least one deflector. The frame contains the filter inside, wherein the frame comprises at least one opening adjacent to at least one side of the filter. The at least one deflector is configured to pivotally connected to the frame, wherein the at least one deflector pivots relative to the frame toward a first rotation direction or a second rotation direction, so that the at least one opening is in an open state or a closed state to expose or cover the at least one side of the filter.

In one embodiment of the present disclosure, the filter assembly further comprises a sliding element and an elastic element. The sliding element is configured to slide along a guiding portion, wherein the guiding portion is perpendicular to a rotating shaft of the deflector; in response to the at least one opening in the closed state, the at least one deflector pivots toward the first rotation direction to expose the filter during the sliding element sliding and approaching the rotating shaft. The elastic element is configured to combine between the frame and the at least one deflector, wherein the at least one elastic element applies a pulling force to the at least one deflector in response to the at least one opening in the open state, the at least one deflector pivots toward the second rotation direction to cover the filter during the sliding element sliding away from the rotating shaft.

In one embodiment of the present disclosure, the guiding portion is disposed on one side of the frame, the sliding element comprises a combining portion, at least one arm, and a towing portion; the combining portion slidably combines the guiding portion, the at least one arm is provided at an end of the combining portion and located on at least one side of the combining portion, the at least one arm is configured to support the at least one deflector, and the towing portion is located at another end of the combining portion and stretches out of the cover.

In one embodiment of the present disclosure, one side of the frame is provided with a first joining portion, one end of the arm is provided with a second joining portion, one side of the deflector is provided with at least one third joining portion and a fourth joining portion, the at least one third joining portion is located between the fourth joining portion and the rotating shaft, the elastic element is disposed between the fourth joining portion and the first joining portion, and the second joining portion and the third joining portion are detachably coupled.

In one embodiment of the present disclosure, the guiding portion is configured as a strip flange, the combining portion is configured as an elongated groove coupled with the strip flange.

In one embodiment of the present disclosure, the filter assembly further comprises head fitting element including two ends, one end is coupled with the towing portion, and another end is coupled with the cover.

In one embodiment of the present disclosure, the at least on deflector comprises a first deflector and a second deflector, one of the two passage portions is integrated with the first deflector, and another of the two passage portions is separated from the second deflector.

In one embodiment of the present disclosure, the at least one filter comprises a single filter, the two passage portions are adjacent to two opposite sides of the filter, and the passage portions are adjacent to two opposite ends of the filter.

In one embodiment of the present disclosure, the at least one filter comprises a plurality of filters arranged side by side, one of the filters is defined as a specific filter, the two passage portions are adjacent to two opposite sides of the specific filter, and the passage portions are adjacent to two opposite ends of the specific filter.

In one embodiment of the present disclosure, the cover is provided with a face-fitting structure, and the breathable part is located in the face-fitting structure.

In one embodiment of the present disclosure, the face-fitting structure is provided with a skin contact portion.

To achieve the above object, the present disclosure provides a filter assembly. The filter assembly comprises a transformable body comprising two passage portions, and at least one filter located between the two passage portions, wherein the transformable body is configured to be transformable to change airflow through the filter.

In one embodiment of the present disclosure, the transformable body comprises a frame and at least one deflector. The frame contains the filter inside, wherein the frame comprises at least one opening adjacent to at least one side of the filter. The at least one deflector is configured to pivotally connected to the frame, wherein the at least one deflector pivots relative to the frame toward a first rotation direction or a second rotation direction, so that the at least one opening is in an open state or a closed state to expose or cover the at least one side of the filter.

In one embodiment of the present disclosure, the filter assembly further comprises a sliding element and an elastic element. The sliding element is configured to slide along a guiding portion, wherein the guiding portion is perpendicular to a rotating shaft of the deflector, in response to the at least one opening in the closed state, the at least one deflector pivots toward the first rotation direction to expose the filter during the sliding element sliding and approaching the rotating shaft. The elastic element is configured to combined between the frame and the at least one deflector, wherein the at least one elastic element applies a pulling force to the at least one deflector in response to the at least one opening in the open state, and the at least one deflector pivots toward the second rotation direction to cover the filter during the sliding element sliding away from the rotating shaft.

In one embodiment of the present disclosure, the guiding portion is disposed on one side of the frame, the sliding element comprises a combining portion, at least one arm, and a towing portion; the combining portion slidably combines with the guiding portion, the at least one arm is provided at an end of the combining portion and located on at least one side of the combining portion, the at least one arm is configured to support the at least one deflector, and the towing portion is located at another end of the combining portion.

In one embodiment of the present disclosure, one side of the frame is provided with a first joining portion, one end of the arm is provided with a second joining portion, one side of the deflector is provided with at least one third joining portion and a fourth joining portion, the at least one third joining portion is located between the fourth joining portion and the rotating shaft, the elastic element is disposed between the fourth joining portion and the first joining portion, and the second joining portion and the third joining portion are detachably coupled.

In one embodiment of the present disclosure, the guiding portion is configured as a strip flange, the combining portion is configured as an elongated groove coupled with the strip flange.

In one embodiment of the present disclosure, the at least on deflector comprises a first deflector and a second deflector, one of the two passage portions is integrated with the first deflector, and another of the two passage portions is separated from the second deflector.

In one embodiment of the present disclosure, the at least one filter comprises a single filter, the two passage portions are adjacent to two opposite sides of the filter, and the passage portions are adjacent to two opposite ends of the filter.

In one embodiment of the present disclosure, the at least one filter comprises a plurality of filters arranged side by side, one of the filters is defined as a specific filter, the two passage portions are adjacent to two opposite sides of the specific filter, and the passage portions are adjacent to two opposite ends of the specific filter.

The air purifier and the filter assembly thereof according to the present disclosure, the filter assembly includes a transformable body and at least one filter. The transformable body is provided with two passage portions, the filter is located between the two passage portions, and the transformable body is configured to be transformable to change the flow rate of air flowing through the filter. Therefore, the filter is suitable for different situations of fixed-location ventilation and smoke protection. The transformable body covers the filter and is used as an escape filter mask. The transformable body reveals the filter and is used in an air purifier, so that the air purifier may integrate the function of an escape filter mask for emergency needs.

### DESCRIPTION OF DRAWINGS

FIG. 1 is a schematic diagram of an air purifier according to an embodiment of the present disclosure.

FIG. 2 is a schematic diagram of an escape filter mask of the air purifier according to an embodiment of the present disclosure.

FIG. 3 is an exploded schematic diagram of the escape filter mask in FIG. 2.

FIG. 4 is an exploded schematic diagram of a filter assembly composed of a single filter according to an embodiment of the present disclosure.

FIG. 5A is a schematic diagram of the filter in FIG. 4 in a purifier mode.

FIG. 5B is a schematic diagram of an airflow direction of the filter in FIG. 5A.

FIG. 6A is a schematic diagram of the filter in FIG. 4 in a smoke filter mode.

FIG. 6B is a schematic diagram of an airflow direction of the filter in FIG. 6A.

FIG. 7 is a schematic diagram of use of the escape filter mask according to an embodiment of the present disclosure.

FIG. 8A is a schematic diagram (1) of a filter assembly composed of several filters in the purifier mode according to an embodiment of the present disclosure.

FIG. 8B is a schematic diagram (2) of a filter assembly composed of several filters in the purifier mode according to an embodiment of the present disclosure.

FIG. 9A is a schematic diagram (1) of a filter assembly composed of several filters in the smoke filter according to an embodiment of the present disclosure.

FIG. 9B is a schematic diagram (2) of a filter assembly composed of several filters in the smoke filter according to an embodiment of the present disclosure.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

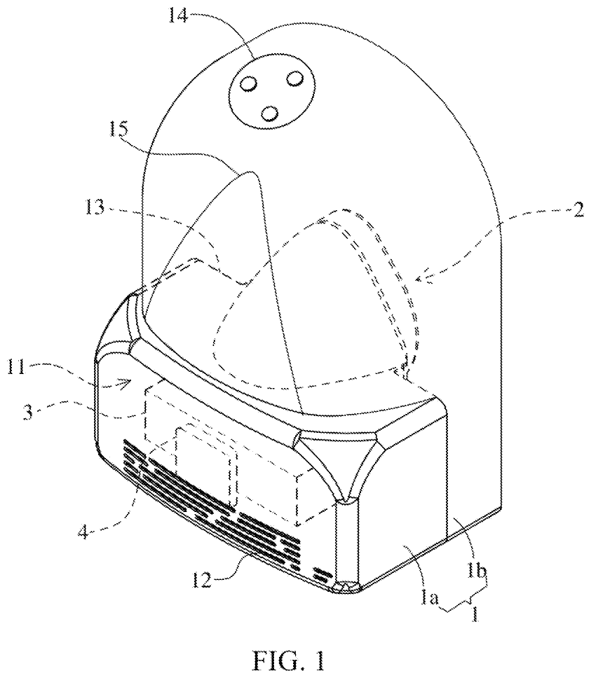

Referring to FIG. 1 to FIG. 3, one aspect of present disclosure provides an air purifier. The air purifier comprises a housing 1, a cover 2, and a filter assembly 3. The housing 1 is used to install the cover 2 and the filter assembly 3, but not limited to this. The housing 1 is also used to install a fan 4, such as an axial flow fan or a blower fan, etc., to assist in generating airflow. The following examples illustrate the implementation of the above-mentioned embodiment of the air purifier of the present disclosure, but it is not limited thereto.

Referring to FIG. 1 to FIG. 3, the housing 1 may be made of plastic. The housing 1 may be composed of multiple components. For example, the housing 1 includes a casing 1a and a shell 1b. For example, the casing 1a has a chamber 11, a venting portion 12, and a holding port 13. The chamber 11 accommodates the filter assembly 3, the venting portion 12 and the holding port 13 are connected to the chamber 11, and the holding port 13 is combined with the cover 2. The casing 1a and the shell 1b may be assembled into a specific type of housing. It should be understood that the housing has a portion for letting air in and out. For example, the venting portion 12 of the casing 1a may be used as a first air portion. The shell 1b is also be provided with a through hole portion (not shown in the figures, such as formed by a plurality if through holes) as a second air portion to assist the passage of air. Thereby, the housing of the air purifier may be composed of multiple components for disassembly, repair, or maintenance operations.

Optionally, in an embodiment, as shown in FIG. 1, the housing 1 is also provided with a control unit 14, for example, the control unit 14 is configured as a control module. The control unit 14 includes a microcontroller and a human-machine interface (such as a touch panel or a combination of buttons and a display). The control unit 14 is also electrically connected to other electrical components, such as power components (such as fans or motors, etc.), power supply sources (such as wires or batteries, etc.), communication units (such as wired or wireless communication transceivers, etc.) and specific functions components (such as negative ion generators, etc.), as the basis for regulating the operation mode of the air purifier. In the embodiment, the control unit 14 is disposed on the shell 1b, and the control unit 14 is electrically connected to the fan 4, but is not limited to this. The fan 4 may also be directly connected to an external power source. As a result, the control unit can centrally control the operation modes of the air purifier, such as start, stop, air volume, timing, and operation mode settings.

Optionally, in an embodiment, as shown in FIG. 1, the partial structure of the housing 1 is also configured into a structure that makes it easy to take out the internal articles. For example, a part of the shell 1b is mortised to form a liftable portion 15 so as to cover and remove a part of the casing 1a and its combined components, such as the cover 2 and the filter assembly 3, but not limited to this. In this way, it is convenient to move and take out the components containing the filter assembly, so as to facilitate the use and maintenance.

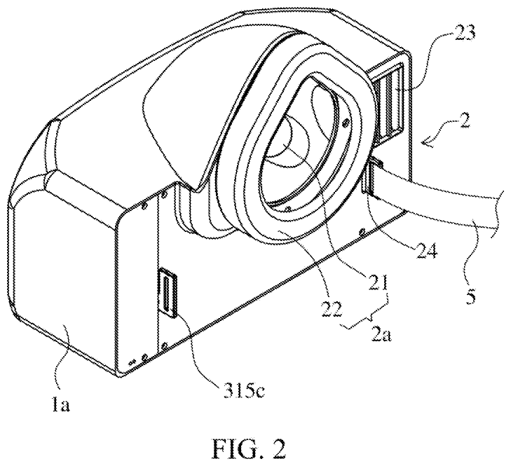

Optionally, in an embodiment, as shown in FIG. 2, the housing 1a, the cover 2, and the filter assembly 3 are configured to form a filter mask, for example, the filter assembly 3 is located in the chamber 11 of the housing 1a, and the filter assembly 3 is combined with the cover 2. The cover 2 is detachably coupled to the holding port 13 of the housing 1a, so that the above-mentioned embodiment implicitly includes the filter mask, which may be taken out from the air purifier in specific situations. For example, separating the casing 1a forming the filter mask from the shell 1b not belonging to the filter mask facilitates emergency escape and other purposes.

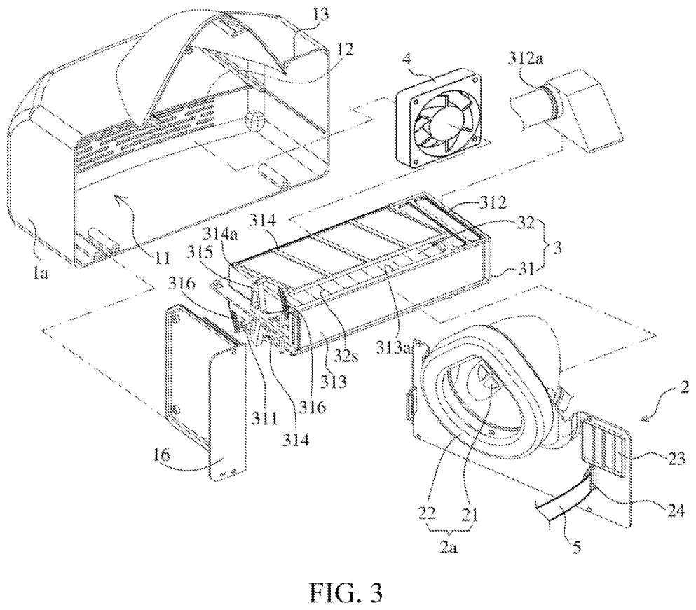

Optionally, in an embodiment, as shown in FIG. 3, the housing 1 is also provided with at least one partition 16 which divides the chamber 11 into several compartments. For example, one of the compartments may accommodate the filter assembly 3. In this way, in addition to making good use of the space inside the housing, different types of objects may be isolated to avoid interference of different functional elements during operation.

Referring to FIG. 3, the cover 2 may be made of plastic. For example, the cover 2 is detachably coupled to the holding port 13 of the housing 1. For example, by detachably combining bolts and screw holes, the cover 2 may be provided with a breathable part 21. The breathable part 21 is configured into a shape suitable for nostril breathing. For example, the breathable part 21 is configured as two breathable holes in a face-fitting structure 2a. For example, each breathable hole may be equipped with a filter, so that the user may inhale or exhale air through the breathable part 21. No limited to this, for example, the face-fitting structure 2a may also be provided with a skin contact portion 22, such as a ring-shaped flexible material (such as a cotton pad, etc.), so as to improve the user's face contact comfort. Not limited to this, the cover 2 is also be provided with a vent 23 to assist in the passage of air.

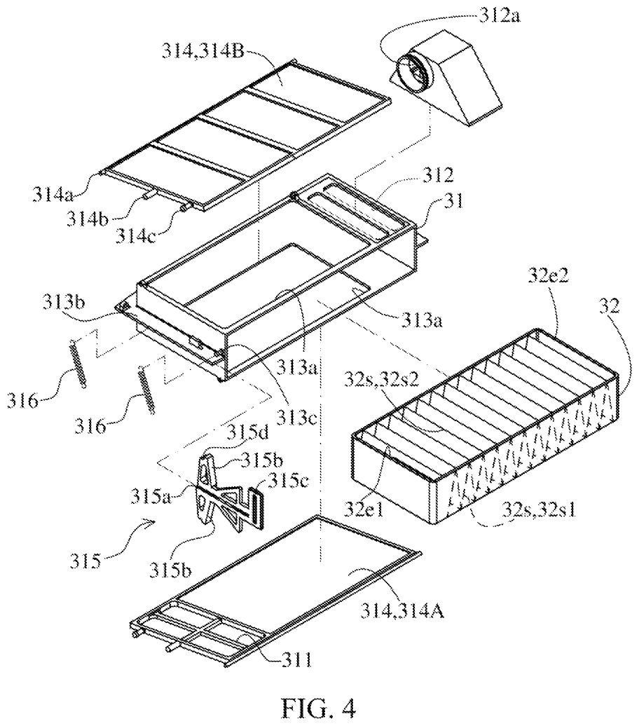

Referring to FIG. 3 to FIG. 4, the filter assembly 3 is composed of plastic and filter elements to form an air filter assembly, and the filter assembly 3 is arranged in a space defined by the casing 1a and the cover 2. For example, the filter assembly 3 is placed in the chamber 11 of the housing 1, and the filter assembly 3 is detachably combined with the cover 2, For example, it can be detachably combined with bolts and screw holes. The filter assembly 3 includes a transformable body 31 and at least one filter 32, and the filter 32 has an air filtering function. For example, the filter 32 may be at least one pleated filter made of randomly arranged chemical fibers or glass fibers, such as a high-efficiency particulate air filter (H EPA) but is not limited thereto.

Referring to FIG. 3 to FIG. 4, the transformable body 31 may be made of plastic, and, for example, the transformable body 31 is provided with two passage portions 311 and 312. It should be understood that in this example, the number of the passage portions is only two for air in and out as an example, but is not limited to this, the passage portions may also be modified into other shapes as required. For example, a single passage portion (such as the passage portion 311 or passage portion 312) may be split into multiple sub-passage portions (such as through holes), for air to flow into or out of the filter 32. For example, the filter 32 is provided between the two passage portions 311 and 312 of the transformable body 31. The transformable body 31 is configured to be transformable. For example, the transformable body 31 may be provided with at least one gate formed by at least one movable member (such as a plate body, a sheet body, a cover body and/or a membrane body, etc.) to expose or cover at least a part of the filter 32 to change the air flow through the filter 32. The venting portion 12, the two passage portions 311, 312, and the breathable part 21 are configured to be coupled in fluid communication. For example, the passage portions 311 and the venting portion 12 are close to each other to be coupled with each other. An air guide 312a (such as a tube body, a cover body, or a combination thereof) may be used between the breathable part 21 and the passage portion 312 to couple with each other, but is not limited to this, so that the air can in communication with each other.

Referring to FIG. 3, in an airflow path passing through the filter assembly 3, for example, the airflow path formed by the venting portion 12 of the housing 1, the two passage portions 311 and 312 of the filter assembly 3, and the breathable part 21 of the cover 2, or the air flow path formed by the venting portion 12, the filter assembly 3, and the vent 23 may be controlled by the fan 4. For example, the fan 4 may be arranged in the housing 1, such as near the venting portion 12, but not is limited to this. The fan 4 is also be adapted to be arranged near the cover 2 or the filter assembly 3 for generating air flow through the filter 32.

The air passing through the air flow path may be filtered by the filter. When the transformable body is configured to transform to reveal the filter, the flow of air filtered through the filter may be increased to adapt to different usage scenarios, such as an air purifier with a fixed-location ventilation function or an escape filter with a smoke protection protection function.

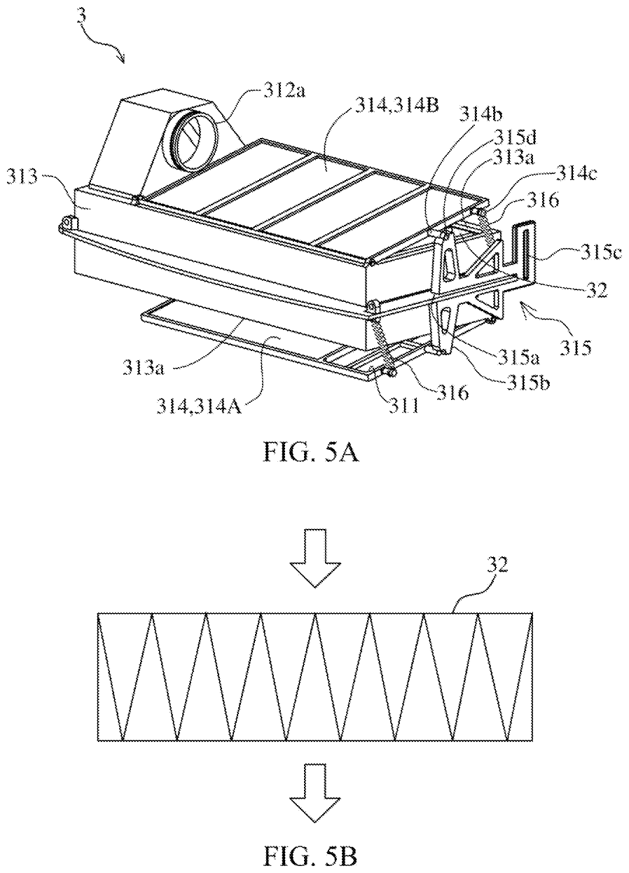

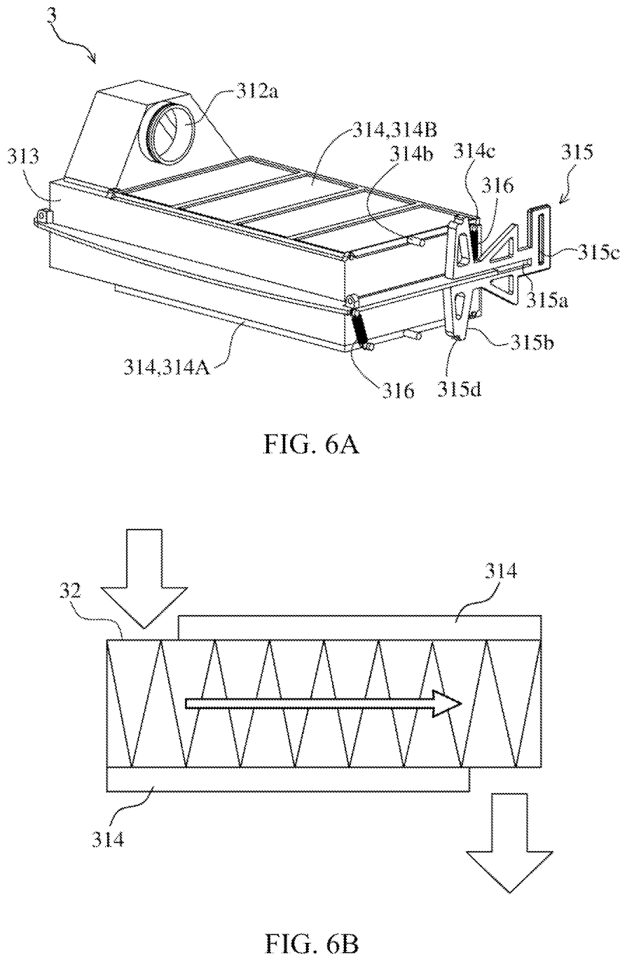

Optionally, in an embodiment, as shown in FIG. 3 and FIG. 4, in the filter assembly 3, the transformable body 31 includes, for example, a frame 313 and at least one deflector 314. For example, the frame 313 may be made of plastic, and the filter 32 may be accommodated in the frame 313. For example, the frame 313 may be formed with a structure (such as a groove, etc.) for accommodating the filter 32 and structures used to guide airflow (such as windows, holes, or pipes, etc.). The frame 313 may also have at least one opening 313a, and the at least one opening 313a is adjacent to at least one side 32s (for example, a filter side) of the filter 32. The at least one opening 313a allows at least one side 32s of the filter 32 to be exposed, allowing air to flow into the filter 32 or out of the filter 32 through the at least one opening 313a. For example, the at least one deflector 314 may be made of plastic. The specifications (such as size and shape, etc.) of the at least one deflector 314 and the at least one opening 313a are compatible with each other, and the at least one deflector 314 is configured to be pivotally connected to the frame 313. For example, a rotating shaft and a shaft hole structure that may pivot to each other are used, the at least one deflector 314 may pivot relative to the frame 313 toward a first rotation direction (for example, counterclockwise), so that the at least one deflector 314 is opposite to each other. The at least one opening 313a is opened to form at least one opened gate. The at least one opening 313a is in an open state (as shown in FIG. 5A) to reveal the at least one side 32s of the filter 32. The at least one deflector 314 and the at least one opening 313a may jointly form at least one air guide portion. For example, the more the at least one deflector 314 pivots away from the filter 32, the more air may be guided to filter through the filter 32. On the other hand, the at least one deflector 314 may pivot in a second rotation direction (for example, clockwise) relative to the frame 313, so that the at least one deflector 314 is covered back relative to the at least one opening 313a to form at least one closed gate. As a result, the at least one opening 313a is in a closed state (as shown in FIG. 6A) to cover the at least one side 32s of the filter 32, so that air may be repeatedly filtered through the filter 32.

Since the at least one deflector is configured to be able to pivot in different directions relative to the frame, the at least one opening is in the open state or the closed state. The air flow of the filter is adjusted according to different usage requirements to adapt to different usage scenarios.

In an embodiment, as shown in FIG. 4 and FIG. 5A, a single filter 32 is taken as an example. The filter 32 has both air cleaning and fire and smoke protection functions. For the convenience of description, the at least one deflector 314 includes a first deflector 314A and a second deflector 314B. The two passage portions 311 and 312 are a first passage portion 311 and a second passage portion 312, and the first passage portion 311 and the first deflector 314A may be integrated with each other. The first passage portion 311 is adjacent to one end 32e1 of the filter 32, and the second passage portion 312 and the second deflector 314B may be separated from each other. The second passage portion 312 is adjacent to the other end 32e2 of the filter 32, and, for example, the first passage portion 311 and the second passage portion 312 are respectively adjacent to two opposite sides 32s1, 32s2 of the filter 32. The second passage portion 312 and the first passage portion 311 are respectively adjacent to the opposite ends 32e1, 32e2 of the filter 32, so that the filter 32 may filter air at a larger portion but is not limited thereto. Thereby, the air passing through the filter may be filtered to the greatest extent, so as to improve the filtering effect.

As shown in FIG. 5A, when the two sides (such as the upper and lower sides) of the filter 32 are exposed, the first deflector 314A and the second deflector 314B respectively pivot towards the two openings 313a away from the frame 313, so that the two openings 313a can be in the open state. The two openings 313a may guide air through the first deflector 314A and the second deflector 314B, so that a large amount of airflow may flow longitudinally through the filter 32 in a large-area filtering manner (as shown in FIG. 5B). Multiple arrows exemplarily indicate the directions of the airflow, which may also be the opposite directions, to improve the ventilation efficiency, so that the filter assembly 3 is in a purifier mode, for example, it may be adapted to be configured for an air purifier. As shown in FIG. 6A, when the two sides (such as the upper and lower sides) of the filter 32 are covered, for example, the first deflector 314A and the second deflector 314B respectively pivot toward the two openings 313a of the frame 313, so that the two openings 313a may be in the closed state. The air may flow through the filter 32 from the two passage portions (311 as shown in the figure) and the surrounding air guide (312a as shown in the figure), allowing an appropriate amount of air flow through the filter 32 in a repeated filtering manner (as shown in FIG. 6B, multiple arrows exemplarily indicate the directions of the air flow, and the directions of the air flow may also be the opposite directions) to improve the filtering effect. The filter assembly 3 is in a smoke filter mode. For example, it can be adapted to be configured as an escape filter mask. The structure of the filter assembly 3 to switch between different modes is illustrated as an example below but is not limited to this.

For example, as shown in FIG. 3 and FIG. 4, the filter assembly 3 further include a sliding element 315 and at least one elastic element 316 for making the at least one opening 313a in the open state or the closed state. The sliding element 315 may be configured to slide along a guiding portion 313b, for example, the guiding portion 313b is perpendicular to a rotating shaft 314a of the deflector 314. The at least one opening 313a is in the closed state. During the sliding element 315 sliding and approaching the rotating shaft 314a, the at least one deflector 314 pivots toward the first rotation direction to be away from the opening 313a until the at least one deflector 314 is supported by the sliding element 315, the at least one opening 313a is in the open state to reveal the filter 32. In addition, the at least one elastic element 316 may be configured to be combined between the frame 313 and the at least one deflector 314. The elastic element 316 is an elastic element (such as a tension spring, etc.) that may be extended to provide tension, and the at least one opening 313a is in the open state. The at least one elastic element 316 is elongated, so that the at least one elastic element 316 may provide a pulling force to the at least one deflector 314. During the sliding element 315 sliding away from the rotating shaft 314a, the at least one deflector 314 pivots toward the second steering to approach the opening 313a until the at least one deflector 314 is blocked by the frame 313, and the at least one opening 313a is in the closed state to cover the filter 32.

Optionally, in an embodiment, as shown in FIG. 3 and FIG. 4, The guiding portion 313b is provided on one side of the frame 313, and the guiding portion 313b is configured as a strip-shaped flange or the like to form a track capable of guiding the sliding element 315 to slide. The sliding element 315 has a combining portion 315a, at least one arm 315b, and a towing portion 315c. The combining portion 315a is configured as an elongated groove. The elongated groove may extend from one end of the sliding element 315 to the inside of the sliding element 315. The elongated groove is slidably combined with the strip flange, so that the sliding element 315 may slide back and forth along the track of the guiding portion 313b. The at least one arm 315b is provided at an end of the combining portion 315a and located on at least one side of the combining portion 315a, and the at least one arm 315b is configured to support the at least one deflector 314. For example, the two arms 315b are located on both sides of the combining portion 315a and are used to support the two deflectors 314. The towing portion 315c (for example, forming a ring or hook, etc.) is located at the other end of the combining portion 315a. The towing portion 315c may extend through the cover 2, the sliding element 315 may be moved away from the rotating shaft 314a by external pulling force, or the sliding element 315 may be moved closer to the rotating shaft 314a by the elastic element 316 exerting a pulling force. Thereby, the sliding element may use the combining portion to slide along the guiding portion, so that the at least one opening is in the closed state or the open state.

Optionally, in an embodiment, as shown in FIG. 4, one side of the frame 313 is provided with a first coupling portion 313c (such as a hook, etc.), and one end of the arm 315b is provided with a second coupling portion 315d (such as a guide groove). At least one third coupling portion 314b (such as a bump, etc.) and a fourth coupling portion 314c (such as a bump, etc.) are provided on one side of the deflector 314. The at least one third coupling portion 314b is located between the fourth coupling portion 314c and the rotating shaft 314a. Taking several third coupling portions as an example, the several third coupling portions may be located equidistantly between the fourth coupling portion 314c and the rotating shaft 314a, so as to adjust the deflector 314 to show a different degree of opening relative to the frame 313. As shown in FIG. 5A and FIG. 6A, the movement of the arm 315b may be designed to be limited by the third coupling portion 314b and the fourth coupling portion 314c. The elastic element 316 is provided between the fourth coupling portion 314c and the first coupling portion 313c, and two ends of the elastic element 316 are detachably fixed between the fourth coupling portion 314c forming the protrusion and the first coupling portion 313c forming the hook body. The second coupling portion 315d and the third coupling portion 314b are detachably coupled. For example, the third coupling portion 314b forming the protrusion and the second coupling portion 315d forming the guide groove are engaged with each other, but is not limited thereto.

When the deflector is pushed to make the at least one opening in the open state, the elastic element provides the pulling force required to restore the closed state. The third coupling portion forming the bump is moved away from the second coupling portion forming the guide groove, and the deflector may be covered by the pulling force to cover the opening. As a result, the overall movable structure may be simplified to reduce manufacturing costs and maintenance difficulty.

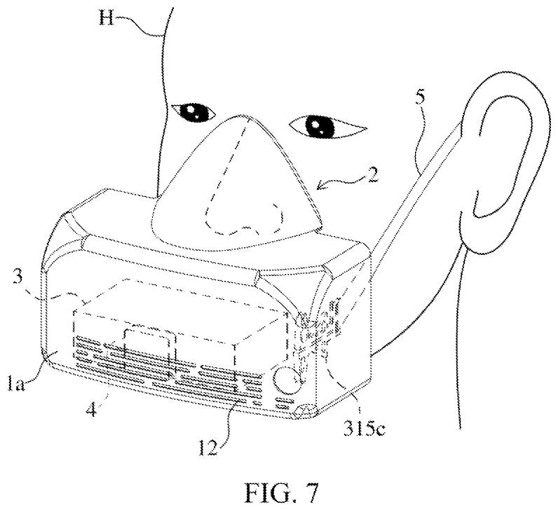

In one embodiment, as shown in FIG. 2 and FIG. 7, the air purifier also includes a head fitting element 5, such as a rubber belt body, etc., the head fitting element 5 has two ends, one of which is connected to the towing portion 315c, and the other end is connected to a suitable coupling portion 24 (such as a ring body or a hook body, etc.) of the cover 2. The user may use the head fitting element to firmly combine the escape filter mask containing the housing, the filter assembly, and the cover on the face, so as not to be easily loosened and to reliably perform breathing and ventilation through the filter assembly.

Optionally, in addition to pulling the sliding element through the head fitting element, the actuation method of the sliding element may also be carried out electrically. For example, a linear motor may be arranged near the sliding element, the linear motor may be controlled (for example, controlled by a microcontroller, etc.), so that the linear motor may be extended and contracted to cause the sliding element to slide by pushing or pulling, but not limited to this. Thereby, the linear motor may be used to adjust the degree of opening of the deflector relative to the frame.

Referring to FIG. 1, in general use, the user operates the above-mentioned embodiment as a fixed-location ventilation function. For example, the filter assembly 3 may be in the purifier mode, and the two openings 313a of the frame 313 are in the open state (as shown in FIG. 5A), so that a large amount of airflow flows longitudinally through the filter 32 (as shown in FIG. 5B) in the large-area filtering manner to improve the ventilation efficiency. On the other hand, in the case of emergency filtering of poisonous gas, such as a fire, the user may operate the above embodiment in a smoke-proof situation. For example, the filter assembly 3 may be in the smoke filter mode. The filter mask formed by the configuration of the housing 1a, the cover 2 and the filter assembly 3 may be separated from the shell 1b and taken out separately (as shown in FIG. 2). As shown in FIG. 7, the head fitting element 5 may be pulled and secured to a user's head H. The towing portion 315c may be pulled to extend the cover 2, so that the filter assembly 3 is in the smoke filter mode. The two deflectors 314 abut the edges of the two openings 313a, so that the two openings 313a of the frame 313 are in the closed state (as shown in FIG. 5A and FIG. 6A). A proper amount of airflow flows laterally through the filter 32 (as shown in FIG. 6B) in the repeated filtering manner to improve the filtering effect, so that the user may breathe the repeatedly filtered air.

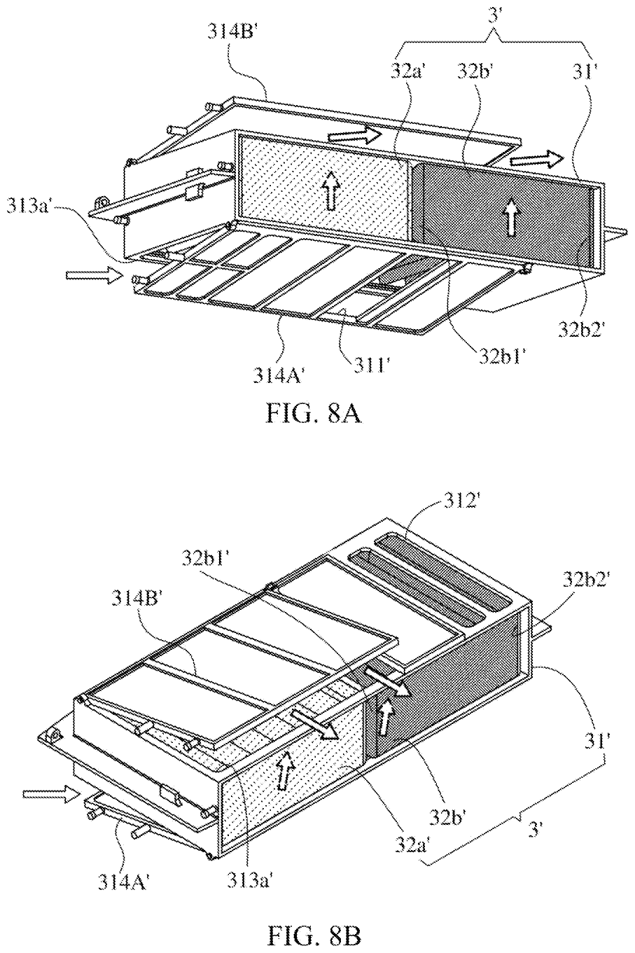

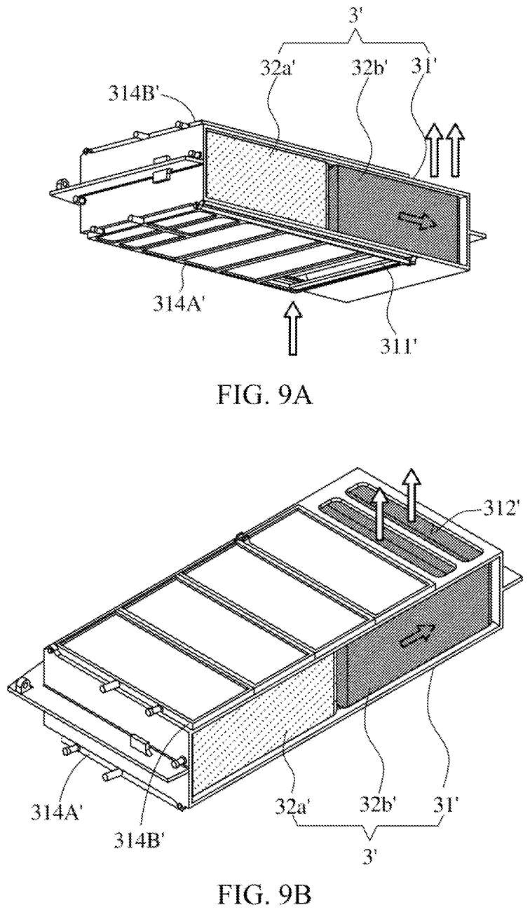

In another embodiment, the number of filters in the filter assembly may also be several, as shown in FIG. 8A, FIG. 8B, FIG. 9A, and FIG. 9B. One filter assembly 3′ may be used to replace the above-mentioned filter assembly 3. The difference between the two filter assemblies 3 and 3′ is mainly explained. The number of filters and correspondingly changed passage portions and deflectors, etc., the remaining components of the filter assembly 3′ are the same as the above-mentioned filter assembly 3 or have corresponding functions. The filter assembly 3′ includes a transformable body 31′ and several filters. Taking two filters as an example, the filter assembly includes a first filter 32a′ and a second filter 32b′. The second filter 32b′ may be a specific filter with a fire alarm and smoke protection function. The first filter 32a′ has an air purifier function, but is not limited to this. The transformable body 31′ may be provided with appropriate partitions or compartments for separately disposing the first filter 32a′ and the second filter 32b′. The transformable body 31′ is provided with a first passage portion 311′, a second passage portion 312′, two openings 313a′, a first deflector 314A′, and a second deflector 3146′. The first deflector 314A′, the second deflector 3146′, and the two openings 313a′ are compatible with each other. Taking the side-by-side arrangement of the first filter 32a′ and the second filter 32b′ as an example, the areas of the two openings 313a′ may be different (but may also be the same). The two openings 313a′ are adjacent to the two side portions formed together of the first filter 32a′ and the second filter 32b′. For any side, one of the two openings 313a′ may be opened or closed, for example, to expose or cover the entire side of the first filter 32a′ and the partial side of the second filter 32b′. In addition, the first passage portion 311′ and the second passage portion 312′ are adjacent to one of the two filters, and, for example, are adjacent to opposite ends of the second filter 32b′. The first passage portion 311′ is adjacent to one end 32b1′ of the second filter 32b′, and the second passage portion 312′ is adjacent to the other end 32b2′ of the second filter 32b′. The first passage portion 311′ and the first deflector 314A′ may be integrated with each other (as shown in FIG. 8A). The second passage portion 312′ and the second deflector 314B′ may be separated from each other (as shown in FIG. 8B).

For example, as shown in FIG. 8A and FIG. 8B, when the two sides (such as upper and lower sides) of the first filter 32a′ and the second filter 32b′ are exposed, the two openings 313a′ are in the open state. A large amount of airflow may be provided to flow longitudinally through the first filter 32a′ and the second filter 32b′ in the large-area filtering manner to improve the ventilation efficiency and make the filter assembly 3′ in the purifier mode. For example, as shown in FIG. 9A and FIG. 9B, when the two sides (such as upper and lower sides) of the first filter 32a′ and the second filter 32b′ are covered, the two openings 313a′ are in the closed state. Air may flow through the second filter 32b′ from the two passage portions 311′ and 312′, allowing a proper amount of air flow to flow laterally through the second filter 32b′ in the repeated filtering manner. Air may flow-in from the first passage portion 311′, and then flow-out from the second passage portion 312′ to improve the filtering effect, so that the filter assembly 3′ is in the smoke filter mode.

On the other hand, the present disclosure also provides a filter assembly. The implementation and effects of the filter assembly have been described above and will not be repeated.

The air purifier and the filter assembly thereof according to the above-mentioned embodiment of the present disclosure, the filter assembly includes a transformable body and at least one filter. The transformable body is provided with two passage portions, the filter is located between the two passage portions, and the transformable body is configured to be transformable to change the flow rate of air flowing through the filter. Therefore, the filter is suitable for different situations of fixed-location ventilation and smoke protection. The transformable body covers the filter and is used as an escape filter mask. The transformable body reveals that the filter is used in an air purifier, so that the air purifier may integrate the function of an escape filter mask for emergency needs.

Although the present disclosure has been disclosed in preferred embodiments, it is not intended to limit the present invention. Anyone who is familiar with this technique may make various changes and modifications without departing from the spirit and scope of the present disclosure. Therefore, the scope of protection of the present disclosure shall be subject to the definition of the attached patent scope.

What is claimed is:

1. An air purifier, comprising:
a housing comprising a casing and a shell being detachable from each other, wherein the casing comprises a venting portion;
a cover comprising at least one breathable part;
a filter assembly configured in a space defined by the casing and the cover, wherein the filter assembly comprises a transformable body and at least one filter, the transformable body comprises two passage portions, the filter is located between the two passage portions, the transformable body is configured to be transformable to change airflow through the filter, and the venting portion, the two passage portions, and the breathable part are coupled in fluid communication; and
a fan disposed in the housing and configured to generate airflow.

2. The air purifier according to claim 1, wherein the casing, the cover, and the filter assembly are configured to form a filter mask.

3. The air purifier according to claim 1, wherein the transformable body comprises:
a frame containing the filter inside, wherein the frame comprises at least one opening adjacent to at least one side of the filter; and
at least one deflector configured to pivotally connected to the frame, wherein the at least one deflector pivots relative to the frame toward a first rotation direction or a second rotation direction, so that the at least one opening is in an open state or a closed state to expose or cover the at least one side of the filter.

4. The air purifier according to claim 3, wherein the filter assembly further comprises:
a sliding element configured to slide along a guiding portion, wherein the guiding portion is perpendicular to a rotating shaft of the deflector; in response to the at least one opening in the closed state, the at least one deflector pivots toward the first rotation direction to expose the filter during the sliding element sliding and approaching the rotating shaft; and
an elastic element configured to combine between the frame and the at least one deflector, wherein the at least one elastic element applies a pulling force to the at least one deflector in response to the at least one opening in the open state, the at least one deflector pivots toward the second rotation direction to cover the filter during the sliding element sliding away from the rotating shaft.

5. The air purifier according to claim 4, wherein the guiding portion is disposed on one side of the frame, the sliding element comprises a combining portion, at least one arm, and a towing portion; the combining portion slidably combines the guiding portion, the at least one arm is provided at an end of the combining portion and located on at least one side of the combining portion, the at least one arm is configured to support the at least one deflector, and the towing portion is located at another end of the combining portion and stretches out of the cover.

6. The air purifier according to claim 5, wherein one side of the frame is provided with a first joining portion, one end of the arm is provided with a second joining portion, one side of the deflector is provided with at least one third joining portion and a fourth joining portion, the at least one third joining portion is located between the fourth joining portion and the rotating shaft, the elastic element is disposed between the fourth joining portion and the first joining portion, and the second joining portion and the third joining portion are detachably coupled.

7. The air purifier according to claim 5, wherein the guiding portion is configured as a strip flange, the combining portion is configured as a elongated groove coupled with the strip flange.

8. The air purifier according to claim 5, wherein the filter assembly further comprises head fitting element including two ends, one end is coupled with the towing portion, and another end is coupled with the cover.

9. The air purifier according to claim 3, wherein the at least on deflector comprises a first deflector and a second deflector, one of the two passage portions is integrated with the first deflector, and another of the two passage portions is separated from the second deflector.

10. The air purifier according to claim 1, wherein the at least one filter comprises a single filter, the two passage portions are adjacent to two opposite sides of the filter, and the passage portions are adjacent to two opposite ends of the filter.

11. The air purifier according to claim 1, wherein the at least one filter comprises a plurality of filters arranged side by side, one of the filters is defined as a specific filter, the two passage portions are adjacent to two opposite sides of the specific filter, and the passage portions are adjacent to two opposite ends of the specific filter.

12. The air purifier according to claim 1, wherein the cover is provided with a face-fitting structure, and the breathable part is located in the face-fitting structure.

13. The air purifier according to claim 12, wherein the face-fitting structure is provided with a skin contact portion.

14. A filter assembly, comprising:
a transformable body comprising two passage portions; and
at least one filter located between the two passage portions;
wherein the transformable body is configured to be transformable to change airflow through the filter.

15. The filter assembly according to claim 14, wherein the transformable body comprises:
a frame containing the filter inside, wherein the frame comprises at least one opening adjacent to at least one side of the filter; and
at least one deflector configured to pivotally connected to the frame, wherein the at least one deflector pivots relative to the frame toward a first rotation direction or a second rotation direction, so that the at least one opening is in an open state or a closed state to expose or cover the at least one side of the filter.

16. The filter assembly according to claim 15, wherein the filter assembly further comprises:
a sliding element configured to slide along a guiding portion, wherein the guiding portion is perpendicular to a rotating shaft of the deflector, in response to the at least one opening in the closed state, the at least one deflector pivots toward the first rotation direction to expose the filter during the sliding element sliding and approaching the rotating shaft; and
an elastic element configured to combined between the frame and the at least one deflector, wherein the at least one elastic element applies a pulling force to the at least one deflector in response to the at least one opening in the open state, and the at least one deflector pivots toward the second rotation direction to cover the filter during the sliding element sliding away from the rotating shaft.

17. The filter assembly according to claim 16, wherein the guiding portion is disposed on one side of the frame, the sliding element comprises a combining portion, at least one arm, and a towing portion; the combining portion slidably combines with the guiding portion, the at least one arm is provided at an end of the combining portion and located on at least one side of the combining portion, the at least one arm is configured to support the at least one deflector, and the towing portion is located at another end of the combining portion.

18. The filter assembly according to claim 17, wherein one side of the frame is provided with a first joining portion, one end of the arm is provided with a second joining portion, one side of the deflector is provided with at least one third joining portion and a fourth joining portion, the at least one third joining portion is located between the fourth joining portion and the rotating shaft, the elastic element is disposed between the fourth joining portion and the first joining portion, and the second joining portion and the third joining portion are detachably coupled.

19. The filter assembly according to claim 17, wherein the guiding portion is configured as a strip flange, the combining portion is configured as a elongated groove coupled with the strip flange.

20. The filter assembly according to claim 15, wherein the at least on deflector comprises a first deflector and a second deflector, one of the two passage portions is integrated with the first deflector, and another of the two passage portions is separated from the second deflector.

21. The filter assembly according to claim 14, wherein the at least one filter comprises a single filter, the two passage portions are adjacent to two opposite sides of the filter, and the passage portions are adjacent to two opposite ends of the filter.

22. The filter assembly according to claim 14, wherein the at least one filter comprises a plurality of filters arranged side by side, one of the filters is defined as a specific filter, the two passage portions are adjacent to two opposite sides of the specific filter, and the passage portions are adjacent to two opposite ends of the specific filter.
